(19) United States
(12) Patent Application Publication
(10) Pub. No.: US 2012/0126607 A1
(43) Pub. Date: May 24, 2012

(54) ADJUSTABLE SHOULDER STRAP MECHANISM FOR BABY STROLLER

(75) Inventors: Lung-Sheng CHEN, Tainan City (TW); Yu-Wen WANG, Chiayi City (TW); Yu-Chien HUANG, New Taipei City (TW)

(73) Assignee: LERADO (ZHONG SHAN) INDUSTRIAL CO., LTD., ZHONG SHAN CITY (CN)

(21) Appl. No.: 13/300,336

(22) Filed: Nov. 18, 2011

(30) Foreign Application Priority Data
Nov. 18, 2010 (CN) 201020611634.8

(51) Int. Cl. B60R 22/10

(52) U.S. Cl. 297/486

(57) ABSTRACT

An adjustable shoulder strap mechanism for baby stroller, provides with a pair of shoulder straps adjustable in height for suitable use of baby or child occupant of different size. The upper end of the shoulder straps can be repositioned by manipulating a driving mechanism accessible on the rear side of the backrest of a stroller. In a preferred embodiment, a head cushioning pad is disposed on the front side of the backrest, following the adjustment of the upper end of the shoulder straps.

### BACKGROUND OF THE INVENTION

1. Field of the Invention

The present invention relates generally to a shoulder strap mechanism for a baby stroller; more particularly, to a shoulder strap which is adjustable in height according to the baby occupant of different size.

2. Description of the Related Art

Baby strollers are designed for travelling baby or child in outdoor. For preventing the baby or child occupant from falling out of baby stroller during travelling, a shoulder strap is extended from the upper portion of the backrest for securing the occupant.

As the upper end of the shoulder strap is fixed to the backrest of the seat and con not be repositioned, it could not be suitable for little occupants with lower shoulder height. Further, the fixed shoulder strap may come to hold around the neck or nose, and cause dangers to those little occupants.

### SUMMARY OF THE INVENTION

To solve the mentioned problem, the present invention provides an adjustable shoulder strap mechanism for baby stroller includes a seat, a guiding plate, a positioning plate, a sliding carrier and a driving mechanism.

The seat has a butt support, a backrest and a pair of shoulder straps, and the guiding plate attaches to the backrest and formed with a longitudinal slot. The positioning plate is attached to the guiding plate and formed with a long slot and a plurality of transverse channels communicated with the long slot.

The sliding carrier is formed with a stem that penetrates through the longitudinal slot and the slots; and the shoulder straps each has an upper end movably guided by the sliding carrier thereby following the sliding carrier to selectively change a height of the upper end of the shoulder straps extend from the sliding carrier relative to the butt support.

The driving mechanism has a main body coupled to the stem for carrying the sliding carrier moving upward and downward along the longitudinal slot and the slots; wherein the driving mechanism includes a movable latch element which can be manipulated to releasably latch into one of the transverse channels for positioning the sliding carrier and the upper end of the shoulder straps.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view showing an adjustable shoulder strap mechanism mounted on a baby stroller according to the present invention.

FIG. 2 is a side view showing the adjustable shoulder strap mechanism mounted on the baby stroller according to the present invention.

FIG. 3 is a rear-left perspective view of the adjustable shoulder strap mechanism.

FIG. 4 is a front-right perspective view of the adjustable shoulder strap mechanism.

FIG. 5 is a front elevational view of the adjustable shoulder strap mechanism.

### DETAILED DESCRIPTION OF THE PREFERRED EMBODIMENTS

Reference will now be made in detail to the preferred embodiments of the present invention; examples of which are illustrated in the accompanying drawings.

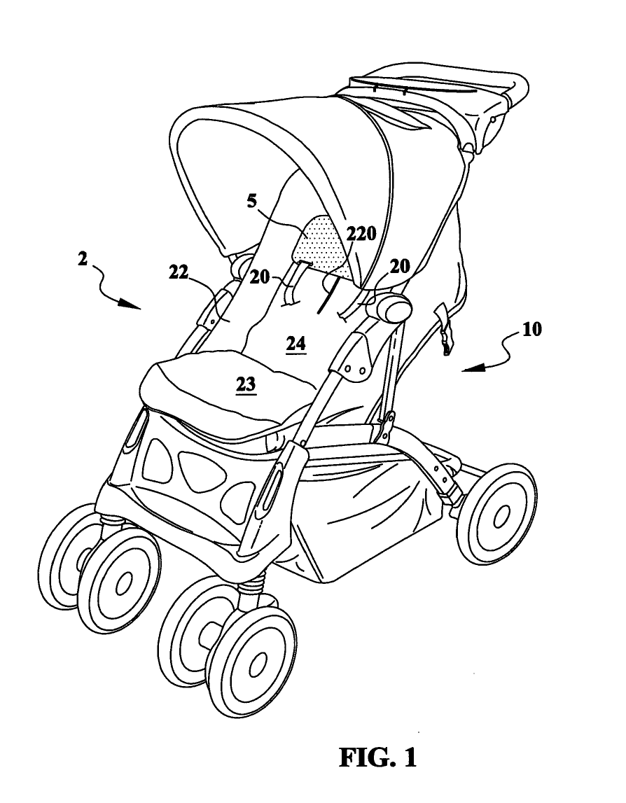

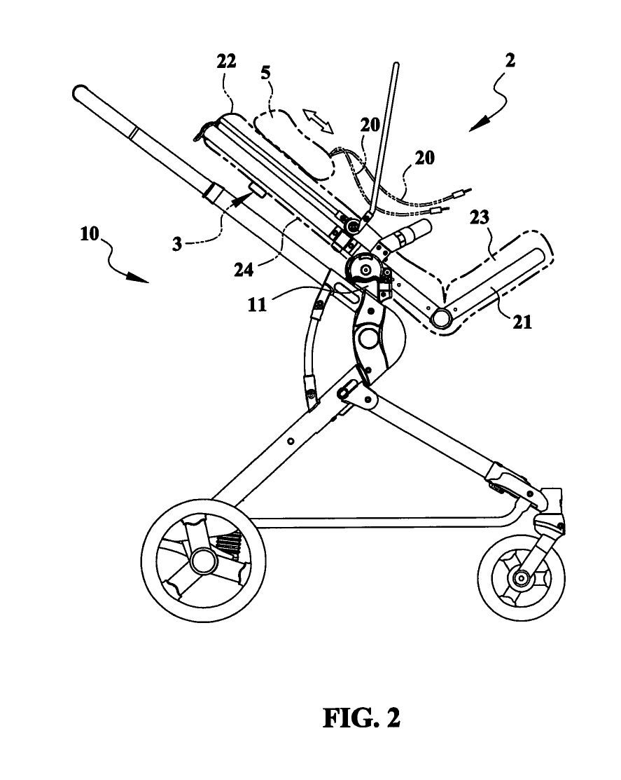

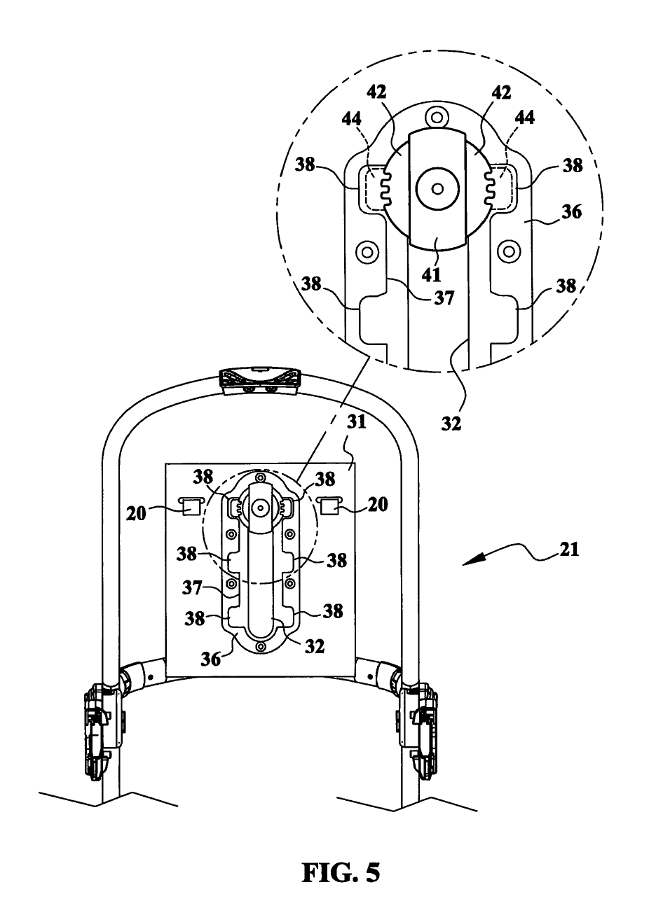

Referring to FIGS. 1 to 5, a preferred embodiment of the an adjustable shoulder strap mechanism 3 for baby stroller includes a seat 2, a guiding plate 31, a positioning plate 36, a sliding carrier 33 and a driving mechanism 4.

The seat 2 has a butt support 23, a backrest 24 and a pair of shoulder straps 20, and the guiding plate 31 attaches to the backrest 24 and formed with a longitudinal slot 32. The seat 2 may be made of plastic and covered with a fabric 22 and has a pair of plugs 25 extended downward for detachably connecting the seat 2 to a stroller frame 10.

Preferably, the seat 2 may include a seat frame 21 which has a pair of plugs 25 and covers with the fabric 22, and connects to a stroller frame 10 which has a pair of sockets 11 for detachably connecting with the plugs 25.

The guiding plate 31 may be made of metal or plastic and mounted on the seat frame 21 by either screws or rivets. The positioning plate 36 is attached to the guiding plate 31 and formed with a long slot 37 and a plurality of transverse channels 38 communicated with the long slot 37.

The sliding carrier 33 is formed with a stem 34 that penetrates through the longitudinal slot 32 and the slots 35; and the shoulder straps 20 each has an upper end movably guided by the sliding carrier 33 thereby following the sliding carrier 33 to selectively change a height of the upper end of the shoulder straps 20 extend from the sliding carrier 33 relative to the butt support 23. Preferably, the fabric 22 may have a longitudinal opening 220 for the stem 34 of the sliding carrier 33 passing therethrough.

The sliding carrier 33 may be formed with a pair of slots 35 and the shoulder straps 20 each has an upper end passed through the slots 35 and extended from the sliding carrier 33. By repositioning the sliding carrier 33, the user can selectively change the height of the upper end of the shoulder straps 20 relative to the butt support 23. In the embodiment, the shoulder straps 20 each has a distal end connected to the guiding plate 31.

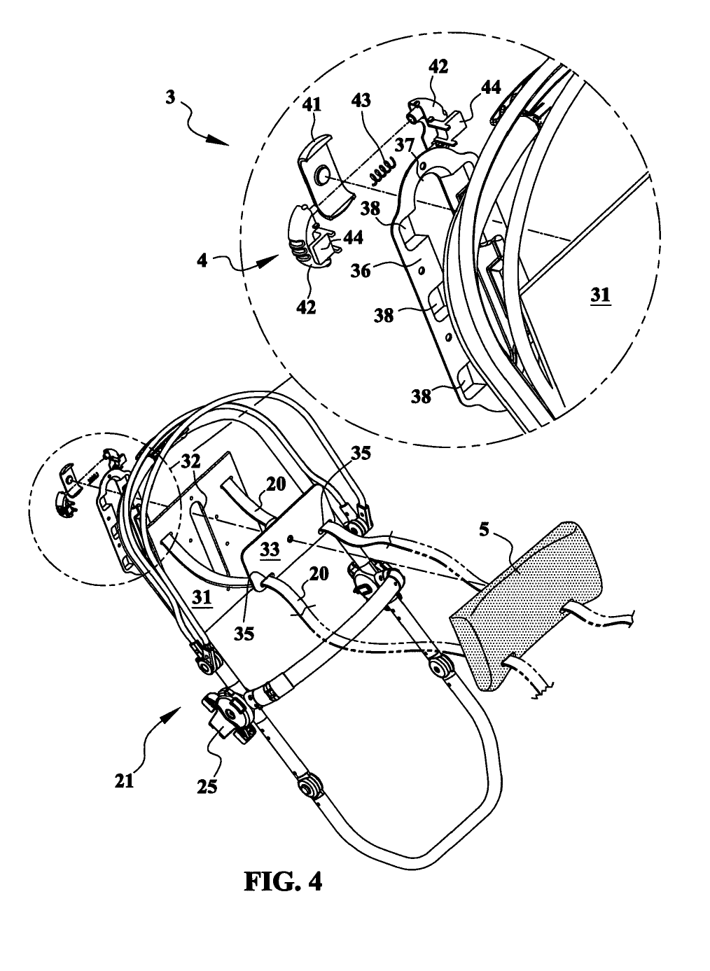

Referring to FIG. 4, the sliding carrier 33 may have a front side attached with a head cushioning pad 5 thereon.

The driving mechanism 4 has a main body 41 coupled to the stem 34 for carrying the sliding carrier 33 moving upward and downward along the longitudinal slot 32 and the slots 35; wherein the driving mechanism 4 includes a movable latch element 44 which can be manipulated to releasably latch into one of the transverse channels 38 for positioning the sliding carrier 33 and the upper end of the shoulder straps 20.

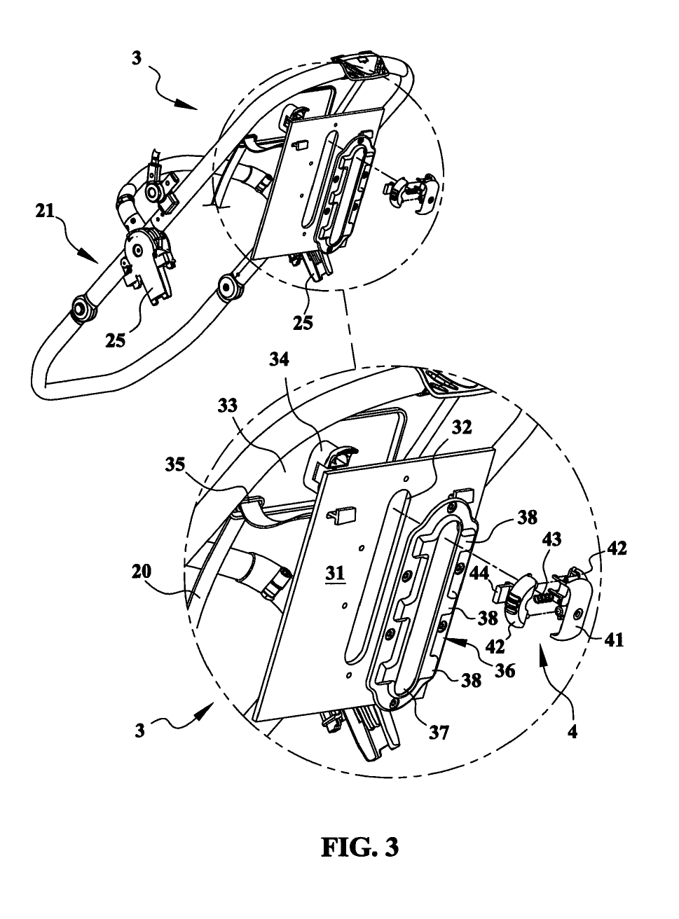

The movable latch element 44 is preferably biased by a resilient member 43 toward one of the transverse channels 38. Referring to FIGS. 3 and 4, the movable latch element 44 may be retractably protruded from the main body 41 and releasably latches into one of the transverse channels 38.

The driving mechanism 4 may further include a button 42 for driving the latch element 44 away from one of the transverse channels 38. Preferably, the driving mechanism 4 is disposed on the rear side of the backrest 24 that is accessible by user.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. An adjustable shoulder strap mechanism for baby stroller, comprising at least:
a seat, having a butt support, a backrest and a pair of shoulder straps;
a guiding plate, attached to the backrest and formed with a longitudinal slot;
a positioning plate, attached to the guiding plate and formed with a long slot, and a plurality of transverse channels communicated with the long slot;
a sliding carrier, formed with a stem penetrated through the longitudinal slot and the slots; and the shoulder straps each having an upper end movably guided by the sliding carrier thereby following the sliding carrier to selectively change a height of said upper end extend from the sliding carrier relative to the butt support; and
a driving mechanism, having a main body coupled to the stem for carrying the sliding carrier moving upward and downward along the longitudinal slot and the slots; wherein the driving mechanism includes a movable latch element which can be manipulated to releasably latch into one of the transverse channels for positioning the sliding carrier and the upper end of the shoulder straps.

2. The adjustable shoulder strap mechanism for baby stroller of claim 1, wherein the movable latch element is biased by a resilient member toward one of the transverse channels.

3. The adjustable shoulder strap mechanism for baby stroller of claim 1, wherein the driving mechanism includes a button for driving the latch element away from one of the transverse channels.

4. The adjustable shoulder strap mechanism for baby stroller of claim 1, wherein the movable latch element is retractably protruded from the main body and releasably latches into one of the transverse channels.

5. The adjustable shoulder strap mechanism for baby stroller of claim 1, wherein the driving mechanism is accessible by user on a rear side of the backrest.

6. The adjustable shoulder strap mechanism for baby stroller of claim 1, wherein the seat is covered with a fabric and has a pair of plugs extended downward for detachably connecting the seat to a stroller frame.

7. The adjustable shoulder strap mechanism for baby stroller of claim 1, wherein the seat includes a seat frame having a pair of plugs and covers with a fabric, and connects to a stroller frame having a pair of sockets for detachably connecting with the plugs.

8. The adjustable shoulder strap mechanism for baby stroller of claim 1, wherein the sliding carrier is formed with a pair of slots and the shoulder straps each has an upper end passed through the slots and extended from the sliding carrier; by repositioning the sliding carrier, the upper end of the shoulder straps can be selectively changed the height relative to the butt support.

9. The adjustable shoulder strap mechanism for baby stroller of claim 7, wherein the shoulder straps each has a distal end connected to the guiding plate.

10. The adjustable shoulder strap mechanism for baby stroller of claim 1, wherein the sliding carrier has a front side attached with a head cushioning pad thereon.

11. The adjustable shoulder strap mechanism for baby stroller of claim 1, wherein the seat includes a seat frame covered with a fabric, and the fabric has a longitudinal opening for the stem of the sliding carrier passing therethrough.
